(19) United States
(12) Patent Application Publication
(10) Pub. No.: US 2012/0091601 A1
(43) Pub. Date: Apr. 19, 2012

(54) FUEL BOOSTER FOR A CARBURETOR

(76) Inventor: Patrick James, Weeki Wachee, FL (US)

(21) Appl. No.: 12/905,551

(22) Filed: Oct. 15, 2010

(51) Int. Cl. F02M 29/00; F02M 19/08; F02M 9/08

(52) U.S. Cl. 261/116; 123/590; 261/79.1; 261/78.1; 261/64.1

(57) ABSTRACT

A fuel booster is adapted for use with a carburetor. The carburetor receives a liquid, such as fuel for an internal combustion engine. The carburetor has a Venturi with a centerline. The booster includes a liquid supply port hole positioned at an end of the booster; and a plurality of liquid port exits positioned along a side of the booster. The booster is adapted to be located at the centerline so that that a liquid received by the carburetor is provided to the booster supply port hole at and below the centerline and generally no liquid is provided to the booster supply port hole above the centerline. A ledge around the liquid port exits may help expose the liquid port exits. An encapsulated O-ring may seal the booster within the carburetor.

### BACKGROUND OF THE INVENTION

The present invention generally relates to fuel systems and more specifically to a fuel booster for a carburetor.

The carburetor determines a major part of an engines power output and engine overall performance. The carburetor dispenses atomized fuel at a proper ratio to enable proper engine operation at varying loads and speeds. Carburetors employ a barrel or barrels with a centrally disposed Venturi and with a mounted throttle valve downstream of the Venturi and at least one booster upstream of the Venturi. Multiple Venturi carburetor designs quite often employ multiple throttle valves and multiple boosters in their design. It is possible to achieve engine performance improvements by modifying these simple components of the design to gain an advantage.

The current device is positioned below the carburetor body Venturi centerline (U.S. Pat. No. 4,482,507) and employs a variable Venturi in its design. This rising variable Venturi hampers performance and requires a booster with a lower mounting point in the carburetor throat area and offers less time for atomizing fuel.

Other devices have been attempted that locate the fuel supply port at the Venturi centerline, yet they expose the upper half of the fuel supply port to a position located above the booster and/or Venturi centerline. This causes loss of low speed signal and may be inferior.

Previous designs did not allow for complete draining of the booster during deceleration or for more instant response to deliver fuel to the engine. On this previous design the fuel port exits were located in the center of the fuel supply port. This design may be inferior as it stores excess fuel that can slosh into the engine when lateral and fore and aft g-forces are experienced. It also requires additional time for fuel enrichment as the fuel supply ports must partially fill before fuel begins to flow when the booster is empty. Also in previous designs, the throttle plate may be mounted inline with the booster. This positioning is not optimal as it delays the booster's exposure to engine air demand and vacuum signal, as a partially open throttle plate will redirect the signal around the booster instead of toward its edges which is required to generate signal and fuel flow. In these designs, a variable Venturi may be created by use of a throttle valve employed above the booster centerline. The employed booster does not create its signal at the booster centerline. Its signal is created above, at and below the actual centerline. By employing fuel port exits drilled at the booster centerline the design may create signal leakage. This loss of signal may be especially important at low air speed rates as it exposes the fuel supply port hole to higher pressure above the booster centerline and delays fuel flow.

It would be desirable to improve poor low air speed signal and poor low air speed fuel atomization, by maximizing available vacuum signal which is generated at the center line of the carburetor Venturi and below the centerline of the booster.

### SUMMARY OF THE INVENTION

In one aspect of the present invention, a booster for a carburetor, the carburetor having a Venturi and the Venturi having a centerline, includes a liquid supply port hole; and a liquid port exit; wherein the booster is adapted to be located at the centerline of the Venturi.

In another aspect of the present invention, a booster for a carburetor that receives a liquid, the carburetor having a Venturi and the Venturi having a centerline, includes a liquid supply port hole positioned at an end of the booster; and a plurality of liquid port exits positioned along a side of the booster; wherein the booster is adapted to be located at the centerline so that that a liquid received by the carburetor is provided to the booster supply port hole at and below the centerline and generally no liquid is provided to the booster supply port hole above the centerline.

In yet another aspect of the present invention, a method of carburetion includes providing a booster having a liquid supply port hole and a liquid port exit; locating the booster at a centerline of a Venturi of a carburetor; and providing a liquid to the booster at and below the centerline so that generally no liquid is provided to the booster above the centerline.

### BRIEF DESCRIPTION OF THE DRAWINGS

FIG. 1 is a cross sectional front view of an embodiment of a carburetor having a booster according to the present invention;

FIG. 2 is a detailed cross sectional side view of the embodiment of FIG. 1; and

FIG. 3 is a side view of an embodiment of a booster according to the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a fuel booster for a carburetor. Embodiments may be used with, but are not limited to, internal combustion engines.

Embodiments of the present invention may fix the fuel distribution point to a position that is at and below the Venturi centerline. This positioning may allow a higher fuel distribution point for increased atomization time and locate the fuel exit ports below the fuel supply port centerline for maximum signal generation and improved booster function. Embodiments may increase the surface area by employing a machined ledge at its centerline for improved atomization. The booster may draw fluids or matter through its ports using a vacuum generating center.

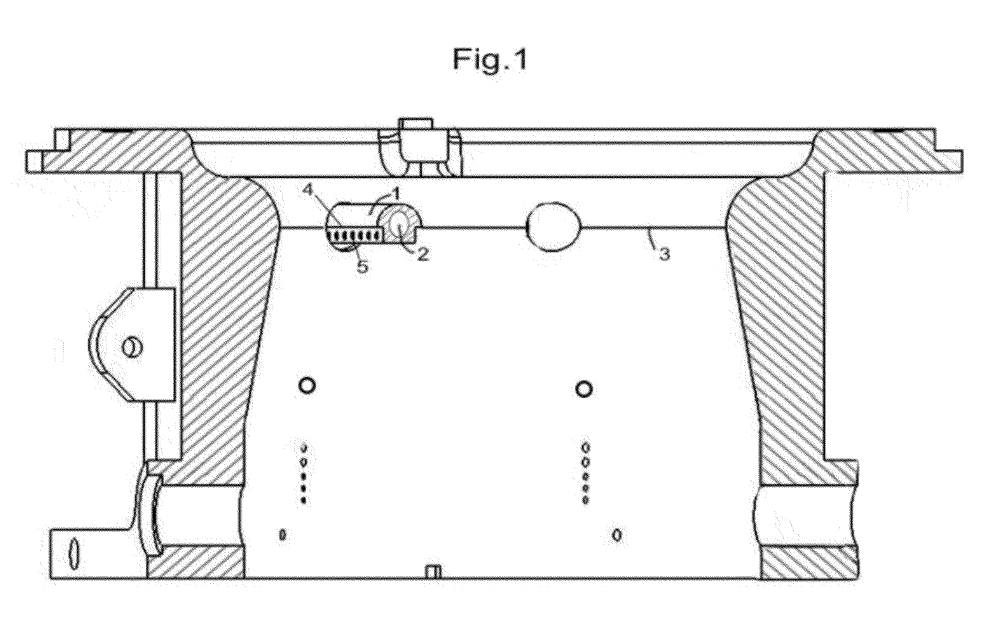

FIG. 1 depicts an embodiment of a carburetor having a fuel booster (1), which has a fuel supply port hole or holes (2) on at least one end, and a machined ledge (4) along a side for fuel port exits (5). The fuel booster (1) is located at and below the Venturi (3) centerline.

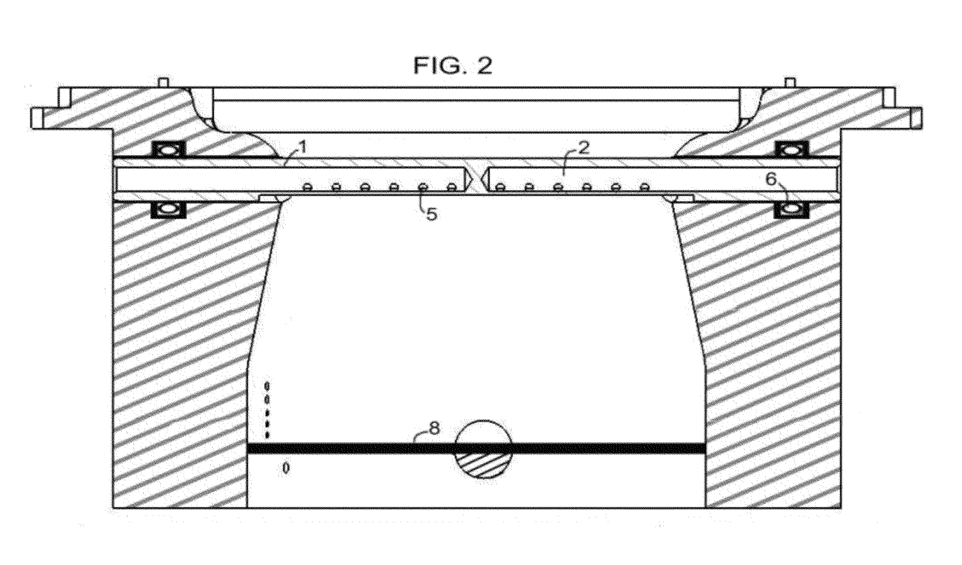

As depicted in FIG. 2, the embodiment of a carburetor may have a fuel booster (1) with a fuel supply port (2) and fuel port exits (5). An encapsulated O-ring sealing system (6) may seal the booster (1). A throttle valve (8) may be located at the base of the Venturi.

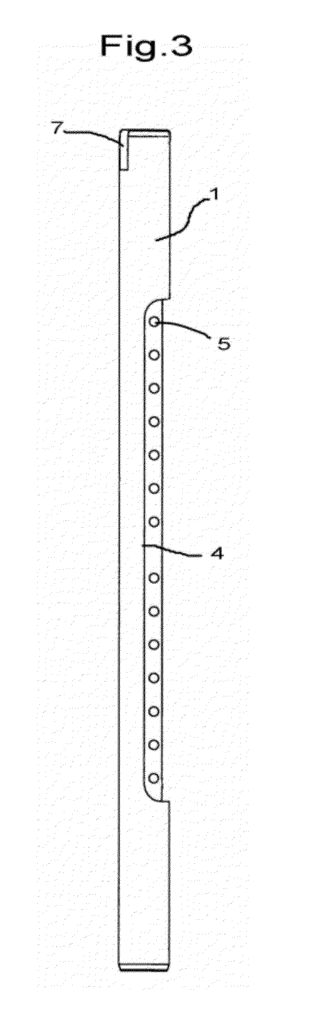

As depicted in FIG. 3, the embodiment of a booster (1) may include a machined ledge (4) that helps expose the fuel port exits (5), and a key slot (7) to help install and locate the booster (1) in relation to the Venturi.

An embodiment of a fuel booster (1) may include a carburetor booster that may generate a vacuum signal and atomize fuel from its outer edges. An embodiment may generate this vacuum signal from the fixed center line of the booster and the fixed centerline of the carburetor Venturi (3) and then deliver fuel from at and below these fixed centerlines. The booster may be installed in the carburetor at a location that allows it to respond to engine air demand and supply atomized fuel to the engine in accordance with its demand. This engine demand may be controlled by means of a throttle valve (8) located at the base of the Venturi (3). Multiple Venturi carburetor designs may typically require multiple boosters and multiple throttle valves in their design. A single Venturi design may require at least one throttle valve to control air demand and may benefit from at least one booster in its Venturi.

An embodiment of a booster (1) may generate vacuum signal at its centerline as a result of engine air demand and resultant air flow over the booster. This generated signal is communicated to the fuel port exits (5), which is communicated to the fuel supply port (2). Those skilled in the art recognize that this signal is then communicated to a carburetor metering block which is communicated to a fuel storage area in the carburetor bowl. This combination of components supplies metered fuel to the Venturi and ultimately into the engine.

An embodiment of a booster (1) may have a fuel supply port (2) with holes along its axis, these holes acting as fuel port exits (5) that distribute fuel from a machined ledge (4) located at the booster center line that gathers generated signal. This signal may be generated by combining the widest area of the booster (1) with the narrowest area of the carburetor Venturi (3). This combination creates a Venturi effect that allows the booster to distribute and atomize fuel into the carburetors Venturi and ultimately into the engine.

In an embodiment, the fuel port exits (5) may be located as close to the centerline of the booster as is possible. The fuel port exits (5) may be sized so they extend to the bottom of the fuel supply port hole or holes (2). The booster may deliver and distribute fuel originating from the fuel supply port (2) located at the Venturi centerline and through fuel exit ports (5) located at and below the Venturi centerline allowing maximum time for fuel atomization and maximum response to signal change.

An embodiment may be sealed against the main body by encapsulated O-rings (6) or other sealings such as press fit designs. Embodiments with an O-ring sealing system (6) may also offer booster vibration dampening to improve consistent fuel draw and delivery.

Embodiments of a booster may be located in position in the carburetor body by a key slot (7) machined into the booster to properly locate its position in relation to the Venturi exit.

The booster may be fitted with an optional machined ledge (4) located at the booster centerline. This ledge may be employed to further maximize gathering of vacuum along the Venturi's center line and increasing the booster's fuel shearing surface area. Other embodiments are without the machined ledge option, but the machined ledge may enhance function. Dyno testing has shown this machined ledge has shown increased power output and decreased fuel consumption at these increased levels of power output.

In an embodiment, the booster fuel port exits (5) may be located close to the centerline of the booster to gather signal generated from that location. The booster fuel port exits (5) may be sized so they extend to the bottom of the fuel supply port holes (2) to allow complete emptying of the fuel supply port holes (2). The booster fuel port exits location (5) may allow for more instant response to fuel demand when the fuel supply port holes (2) are initially empty and begin flowing fuel to supply the fuel port exits (5). This embodiment may allow for clean deceleration as there is little or no residual fuel resting in the fuel supply port that can enter the engine during sudden deceleration and when engine demand is stopped.

An embodiment of a booster may be machined from a solid stock of material, drilled down its length, machined along its side, and then drilled through its sides to supply fuel to the Venturi area.

An embodiment of a booster may generate signal from both a fixed booster centerline and a fixed Venturi centerline. An embodiment may distribute fuel from fuel port exits located along its body. An embodiment may have fuel port exits that allow complete draining of the fuel supply port holes. An embodiment may have the fuel supply port holes beginning at and extending below the Venturi centerline. An embodiment may be sealed by use of encapsulated O-rings. An embodiment may be perpendicular to throttle valve rotation angle. An embodiment may avoid exposing the fuel supply port to the higher pressure located above the booster and/or Venturi centerline.

I claim:

1. A booster for a carburetor, the carburetor having a Venturi and the Venturi having a centerline, the booster comprising:
a liquid supply port hole; and
a liquid port exit;
wherein the booster is adapted to be located at the centerline of the Venturi.

2. The booster of claim 1, wherein the booster adapted to be positioned so that a liquid is provided to the booster at and below the centerline and generally no liquid is provided to the booster above the centerline.

3. The booster of claim 1, further comprising:
a carburetor having the Venturi and the centerline of the Venturi;
wherein the booster's supply port hole is positioned relative to the carburetor so that that a liquid received by the carburetor is provided to the booster supply port hole at and below the centerline and generally no liquid is provided to the booster supply port hole above the centerline.

4. The booster of claim 1, wherein the supply port hole is positioned at an end of the booster and a plurality of liquid port exits are positioned along a side of the booster.

5. The booster of claim 1, further comprising:
a ledge around a plurality of liquid port exits that helps expose the liquid port exits.

6. The booster of claim 1, wherein the booster draws fluids or matter through the liquid supply port hole using a vacuum generating signal so as to atomize liquid from an outer edge of the booster.

7. The booster of claim 1, wherein the liquid port exit allows generally complete draining of a liquid provided to the liquid supply port hole.

8. The booster of claim 1, further comprising an encapsulated O-ring adapted to seal the booster within the carburetor.

9. The booster of claim 1, wherein the carburetor further includes a throttle valve having a rotation angle, and the booster is adapted to be positioned perpendicular to the throttle valve rotation angle.

10. The booster of claim 1, wherein the liquid is a fuel, and the carburetor is for an internal combustion engine.

11. A booster for a carburetor that receives a liquid, the carburetor having a Venturi and the Venturi having a centerline, the booster comprising:
a liquid supply port hole positioned at an end of the booster; and
a plurality of liquid port exits positioned along a side of the booster;
wherein the booster is adapted to be located at the centerline so that that a liquid received by the carburetor is provided to the booster supply port hole at and below the centerline and generally no liquid is provided to the booster supply port hole above the centerline.

12. The booster of claim 11, further comprising:
a ledge around the liquid port exits that helps expose the liquid port exits.

13. The booster of claim 11, further comprising:
an encapsulated O-ring adapted to seal the booster within the carburetor.

14. The booster of claim 11, further comprising:
a carburetor having the Venturi and the centerline of the Venturi;
wherein the booster's supply port hole is positioned relative to the carburetor so that that a liquid received by the carburetor is provided to the booster supply port hole at and below the centerline and generally no liquid is provided to the booster supply port hole above the centerline.

15. A method of carburetion, comprising:
providing a booster having a liquid supply port hole and a liquid port exit;
locating the booster at a centerline of a Venturi of a carburetor; and
providing a liquid to the booster at and below the centerline so that generally no liquid is provided to the booster above the centerline.

16. The method of claim 15, further comprising:
drawing the liquid into the booster through the liquid supply port hole using a vacuum generating signal; and
atomizing the liquid from an outer edge of the booster.

17. The method of claim 15, wherein the carburetor includes a throttle valve having a rotation angle, the method further comprising:
positioning the booster perpendicular to the throttle valve rotation angle.

18. The method of claim 15, further comprising:
providing the carburetor; and
positioning the booster's supply port hole relative to the carburetor so that that a liquid received by the carburetor is provided to the booster supply port hole at and below the centerline and generally no liquid is provided to the booster supply port hole above the centerline.
